(19) United States
(12) Patent Application Publication
(10) Pub. No.: US 2003/0204813 A1
(43) Pub. Date: Oct. 30, 2003

(54) Electronic document filing system

(76) Inventors: Martin Hermann Krause, Bristol (GB); Peter Gifford, Bristol (GB)

Correspondence Address: GREER, BURNS & CRAIN, 300 S WACKER DR, 25TH FLOOR, CHICAGO, IL, 60606, US

(21) Appl. No.: 10/132,092

(22) Filed: Apr. 25, 2002

(51) Int. Cl. G06F 15/00; G06F 17/00

(52) U.S. Cl. 715/506; 715/505

(57) ABSTRACT

An electronic document filing apparatus is disclosed which enables an agent to file a document at an office on behalf of a client. The apparatus comprises a client interaction unit which prompts the client for information relating to the document and which receives the information from the client, a document producing unit which produces an electronic version of the document from the information received from the client, and a communication unit which communicates the electronic version of the document to the agent to enable the agent to file the document at the office. The apparatus may enable the filing of, for example, an intellectual property document such as a trademark, design or patent to be simplified.

### BACKGROUND OF THE INVENTION

1. Field of the Invention

The present invention relates to an electronic document filing system, such as a remote on-line trademark application filing system.

2. Description of the Related Art

FIG. 1 of the accompanying drawings illustrates a conventional procedure which is undertaken by a client 10 who wishes to file an application for registration of a trademark at a local or foreign trademark office. The client 10 collects together all the relevant information concerning the trademark application, for example details of the applicant, the type of trademark to be applied for, the goods and services to which the trademark is to be applied, any convention priority information and any other information required for the application. The information that has been collected together is noted down and transmitted, for example, by letter 20, to a local agent 30 in the country or territory where the application for registration of the trademark is to be filed. Using the information provided by the client 10, the agent 30 then arranges for the trademark information to be input onto the agent's computer system 40 which is subsequently, using that information, operated to produce a trademark application form 50 that is filed at the appropriate trademark Office 60.

The procedure illustrated in FIG. 1 and as described above may require a great deal of input in terms of time and effort by the agent 30, for example in reviewing the information provided by the client 10 and arranging for that information to be processed and input onto the agent's local computer system 40, as well as the subsequent checking of the trademark application form 50 which is produced. This results in an increase in the cost to the client 10 in filing a trademark application through this procedure, and an increase in the likelihood of transcription errors.

It is therefore desirable to provide a trademark filing system and procedure which is simpler and more cost-effective for the client and which minimises the likelihood of transcription errors.

### SUMMARY OF THE INVENTION

One aspect of the present invention provides an electronic document filing apparatus which enables an agent to file a document at an office on behalf of a client, said apparatus comprising a client interaction unit which prompts the client for information relating to the document, and receives said information from the client, a document producing unit which produces an electronic version of the document from the information received from the client, and a communication unit which communicates said electronic version of said document to said agent to enable the agent to file said document at said office.

The present invention may provide a simple and cost effective way of filing a document such as a trademark application. Furthermore, the present invention may require fewer transcriptions to be made than in the conventional trademark filing procedure, thereby reducing the likelihood of transcription errors occurring.

Another aspect of the present invention provides an electronic document filing system which enables an agent to file a document at an office on behalf of a remote client, said apparatus comprising a client terminal, an on-line filing server in communication with said client terminal via a network, and an agent terminal in communication with said on-line filing server, said on-line filing server comprising a client interaction unit which prompts said remote client terminal for information relating to the document via said network, and receives said information from the remote client terminal via said network, a document producing unit which produces an electronic version of the document from the information received from the remote client terminal, and a communication unit which communicates said electronic version of said document to said agent terminal to enable the agent to file said document at said office.

Another aspect of the invention provides a client terminal which is programmed to enable a client to instruct an agent to file an intellectual property document at a remote intellectual property office, the client terminal comprising a client interaction unit which prompts the client for information relating to the document, and receives said information from the client, a document producing unit which produces an electronic version of the document from the information received from the client, and a communication unit which communicates said electronic version of said document to said agent to enable the agent to file said document at said office.

Another aspect of the invention provides an electronic document filing method which enables an agent to file a document at an office on behalf of a client, said method being carried out electronically and comprising the steps of prompting said client for information relating to said document, receiving said information from said client, producing an electronic version of the document from the information received from the remote client, and communicating said electronic version of said document to said agent to enable the agent to file said document at said office.

Another aspect of the invention provides a method of instructing an agent to file an intellectual property document at a remote intellectual property office, the method comprising the steps of logging on to an electronic filing apparatus provided by the agent, receiving a prompt for information relating to said document from said electronic filing apparatus, sending information relating to said document to said electronic filing apparatus, and receiving confirmation that said information has been received.

Another aspect of the invention provides an electronic document filing apparatus for enabling an agent to file a document at an office on behalf of a client, the apparatus comprising means for prompting the client for information relating to the document, means for receiving said information from the client, means for producing an electronic version of the document from the information received from the client, and means for communicating said electronic version of said document to said agent to enable the agent to file said document at said office.

Another aspect of the invention provides a computer readable recording medium storing a program for use in an electronic document filing apparatus which enables an agent to file a document at an office on behalf of a client, said program comprising a client interaction program portion which prompts the client for information relating to the document and receives said information from the client, a document producing program portion which produces an electronic version of the document from the information received from the client, and a communication program portion which communicates said electronic version of said document to said agent to enable the agent to file said document at said office.

Another aspect of the invention provides a computer readable recording medium storing a program for use in a client terminal which is programmed to enable a client to instruct an agent to file an intellectual property document at a remote intellectual property office, the program comprising a client interaction program portion which prompts the client for information relating to the document, and receives said information from the client, a document producing program portion which produces an electronic version of the document from the information received from the client, and a communication program portion which communicates said electronic version of said document to said agent to enable the agent to file said document at said office.

The invention may also provide a computer program which, when run on a computer, causes it to carry out any of the methods described herein, or to function as any of the apparatuses described herein.

Features of one aspect of the invention may be applied to other aspects. Method features may be applied to apparatus aspects and vice versa.

### BRIEF DESCRIPTION OF THE DRAWINGS

FIG. 1, described hereinbefore, illustrates a conventional procedure for filing an application for registration of a trademark;

FIG. 2 is a diagram giving an overview of an online document filing system according to an embodiment of the present invention;

FIG. 3 is a block diagram showing a more detailed overview of an on-line document filing system embodying the present invention;

FIG. 4 is a flow diagram showing the key steps performed by an on-line filing system embodying the present invention;

FIG. 5 is a block diagram showing in more detail the structure of the on-line filing server shown in FIGS. 2 and 3;

FIG. 6 is a flow diagram showing the steps performed by the client interaction unit of FIG. 5;

FIG. 7 is a screen shot relating to the step S1 shown in FIG. 6;

FIG. 8 is a screen shot relating to the step S2 shown in FIG. 6;

FIG. 9 is a screen shot relating to the step S3 shown in FIG. 6;

FIG. 10 is a screen shot relating to the step S4 shown in FIG. 6;

FIG. 11 is a screen shot relating to the step S5 shown in FIG. 6;

FIG. 12 is a screen shot relating to the step S6 shown in FIG. 6;

FIG. 13 is a screen shot relating to the step S8 shown in FIG. 6;

FIG. 14 is a screen shot relating to the step S9 shown in FIG. 6;

FIG. 15 is a screen shot relating to the step S10 shown in FIG. 6;

FIG. 16 is a screen shot illustrating the arrival at the client terminal of a confirmation e-mail; and

FIG. 17 is a screen shot showing the administrative tasks available to the agent or administrator.

### DETAILED DESCRIPTION OF THE PREFERRED EMBODIMENTS

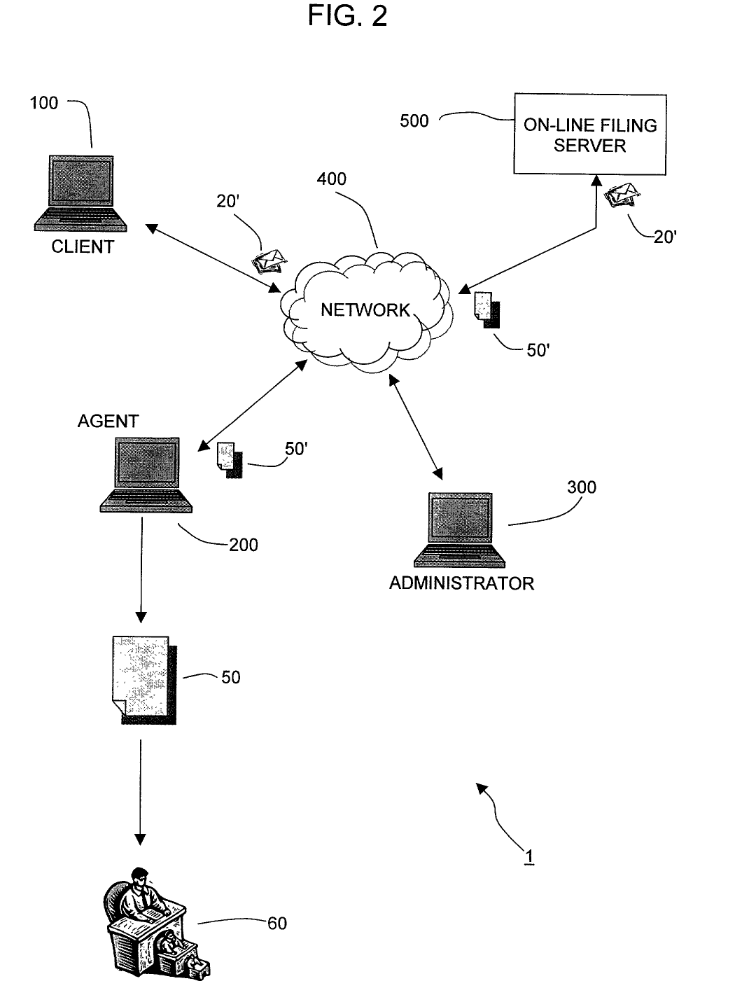

FIG. 2 is an overview diagram illustrating an online document (e.g. trademark application) filing system and procedure according to an embodiment of the present invention. The present embodiment will be described in relation to the filing of a trademark application, although the invention may be used for the filing of any document through the intermediary of an agent. For example the invention may also be used for the filing of a registered design application or a patent application.

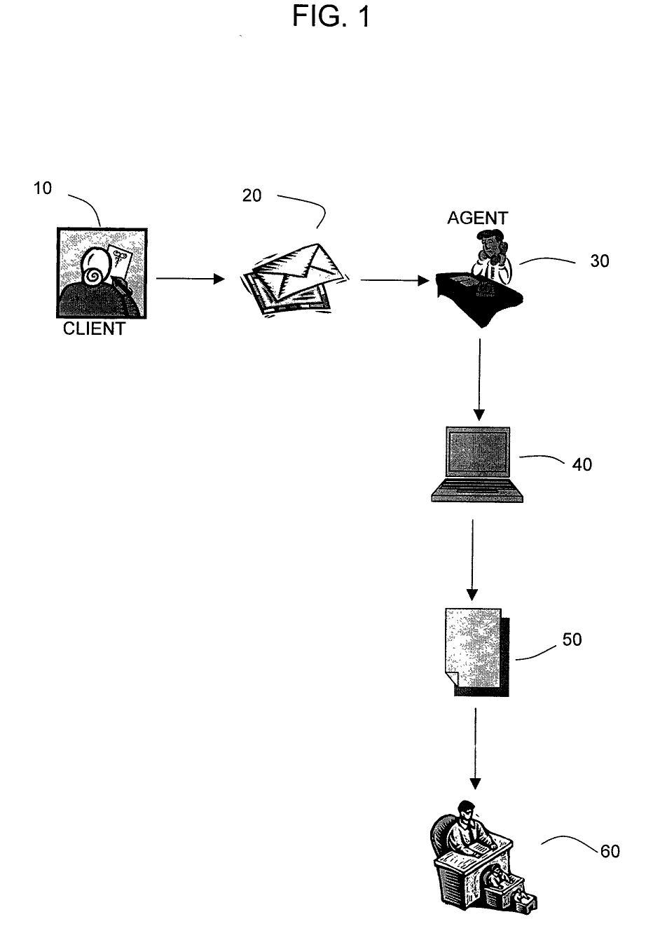

The on-line document (trademark) filing system 1 comprises a client terminal 100 which is connected via a network 400 to an on-line filing server 500. The client terminal 100 is located at the site of the client 10 of FIG. 1 who wishes to file an application for the registration of (for example) a trademark. An agent terminal 200, which is located at the site of the agent 30 of FIG. 1, is also connected and in communication with the on-line filing server 500 via the network 400 (or via a separate network). Likewise, an administrator terminal 300 is connected and in communication with the on-line filing server 500 via the network 400.

In the on-line filing system 1 of the present embodiment, information 20′ relating to the trademark application to be filed is sent from the client terminal 100 over the network 400 to the on-line filing server 500. This information 20′ corresponds to the information 20 described above with reference to FIG. 1. This information 20′ is received by the on-line filing server 500 and is used to generate an electronic trademark application form 50′ which is then sent to the agent terminal 200 over the network 400. In this embodiment, the agent terminal 200 receives the electronic trademark application form 50′ and from that produces a hard-copy trademark application form 50 which corresponds to the like-numbered trademark application form 50 described above with reference to FIG. 1. This hard-copy trademark application form 50 is subsequently filed in the same manner as described above with reference to FIG. 1 at the relevant trademark office 60. As will be described in more detail below, the collating and entering of the information 20′ relating to the trademark application at the client terminal 100 can be controlled by the online filing server 500. This ensures that the client 10 is helped and guided through the information-entering process and helps to ensure that all the required information is provided for a successful trademark application.

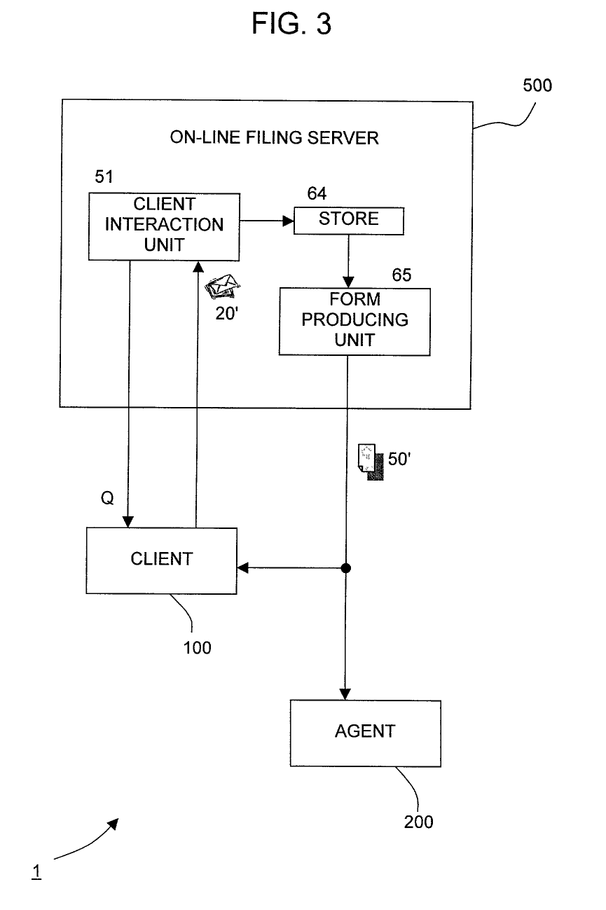

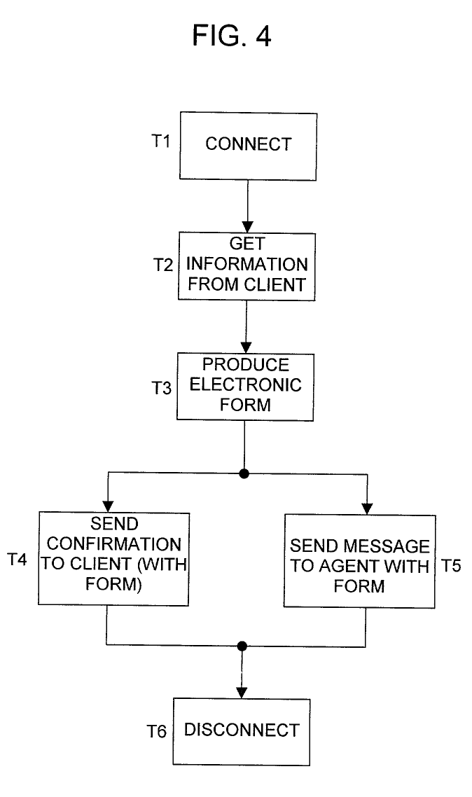

FIG. 3 is a block diagram showing a more detailed overview of the on-line filing system 1 of FIG. 2. The on-line filing server 500 in this embodiment comprises a client interaction unit 51, a store 64 and a form producing unit 65. Operation of these parts will be described with reference to the flowchart shown in FIG. 4.

In step T1 of FIG. 4, the client terminal 100 connects with the on-line filing server 500. Once this connection is made, the client interaction unit 51 of the on-line filing server proceeds to request information from the client terminal 100 via a series of queries Q. In response to these queries Q, the client 10 provides, through the client terminal 100, the required information 20′ which is sent to the online filing server 500 and on to the client interaction unit 51 which requested that information. This information 20′ may then be stored in a store 64 (this may be a temporary store) and once all the information that is required has been gathered by the client interaction unit 51, in step T3 the form producing unit 61 of the on-line filing server 500 produces an electronic trademark application form 50′.

The on-line filing server 500 then causes, in step T4, a confirmation message to be sent to the client 100, for example by e-mail over the network 400. This message confirms to the client that the application form has been produced and will be sent to the agent 30 via the agent terminal 200 for subsequent processing. This confirmation message preferably includes a copy of the electronic form 50′ produced by the form producing unit 65 to enable the client 10 to view the final result of his input.

At the same time, in step T5 the on-line filing server 500 causes a message to be sent to the agent's terminal 200 which will, for example, inform the agent 30 that one of his clients has requested a trademark application. This message will preferably include a copy of the electronic form 50′, which can optionally be checked by the agent 30 before printing, signing and filing at the trademark office 60.

After the above steps have been performed, in step T6 the client terminal 100 disconnects from the on-line filing server 500.

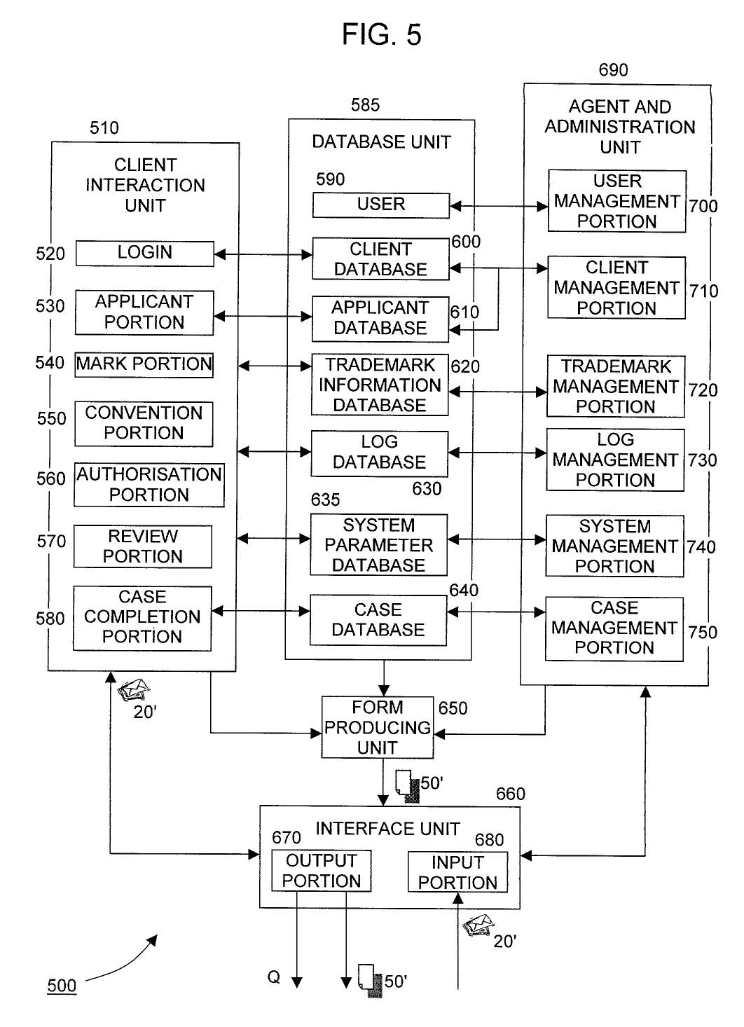

The on-line filing server 500 and its operation will now be described in more detail with reference to FIGS. 5 to 17. The on-line filing server in this embodiment comprises a client interaction unit 510, a database unit 585, an agent and administration unit 690, an interface unit 660 and a form producing unit 650. The client interaction unit 510 is responsible for guiding the client 10 through the application procedure so as to gather all the necessary information for the trademark application. The client interaction unit 510 is in communication with the database unit 585, the form producing unit 650 and the interface unit 660. The agent and administration unit 690 is responsible for the management functions of the on-line filing server 500 and the information stored within the database unit 585, and will be described in more detail below.

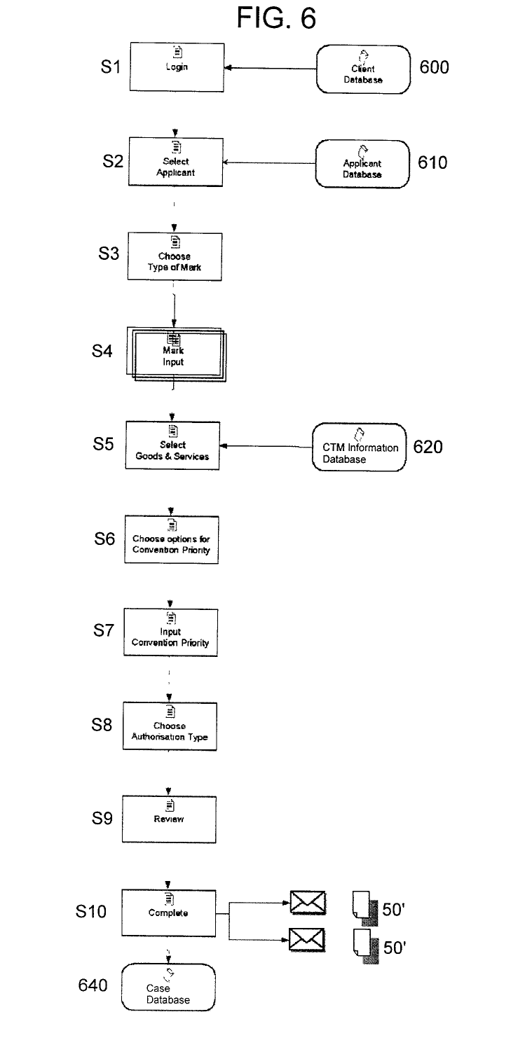

The client interaction unit 510 comprises a login portion 520, an applicant portion 530, a mark portion 540, a convention portion 550, an authorisation portion 560, a review portion 570 and a case completion portion 580. The database unit 585 comprises a user database 590, a client database 600, an applicant database 610, a trademark information database 620, a log database 630, a system parameter database 635 and a case database 640. The agent and administration unit 690 comprises a user management portion 700, a client management portion 710, a trademark management portion 720, a log management portion 730, a system management portion 740 and a case management portion 750. The interface unit 660 comprises an output portion 670 and an input portion 680. Detailed operation of these components of the on-line filing server 500 will now be described with reference to FIG. 6.

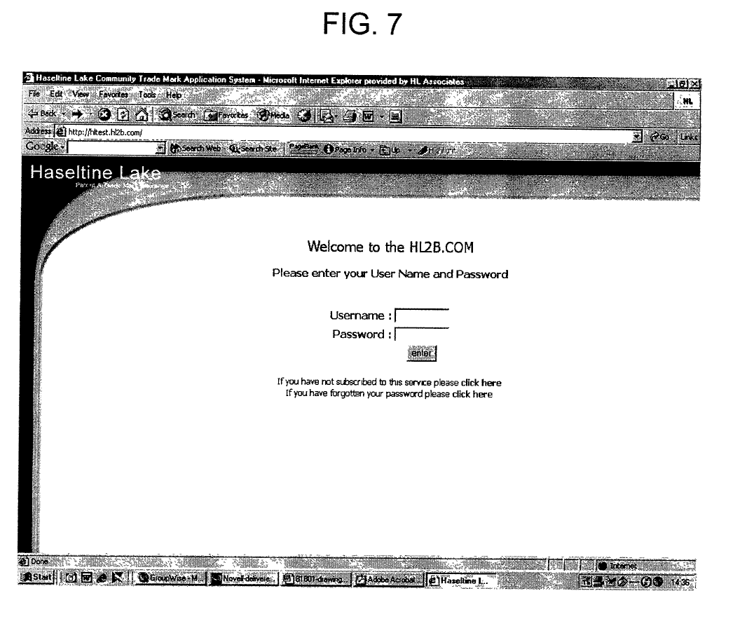

FIG. 6 is a flowchart illustrating the operations carried out by the client interaction unit 510 in the on-line filing server 500. These operations are carried out in communication with the client terminal 100 shown in FIG. 2. The client terminal 100 firstly connects on to the on-line filing server 500 via the network 400. For example, in the case where the network is the Internet, this may be done over the Internet using a web browser. In order to gain access to the on-line filing server 500, the client terminal 100 is taken through a login step S1, controlled by the login portion 520 shown in FIG. 5. The client 10 will have been pre-allocated a user name and password to gain access to the on-line filing server 500, and these details are entered by the client 10 at the site of the client terminal 100, for example as shown by the example screen shot shown in FIG. 7.

Once the client terminal 100 has sent the user name and password input by the client 10 to the on-line filing server 500, the interface unit 660 passes this information to the login portion 520 of the client interaction unit 510. The login portion 520 then queries the client database 600 in the database unit 585 to determine whether the details match an entry in the client database 600. If so, access is granted and processing passes to step S2.

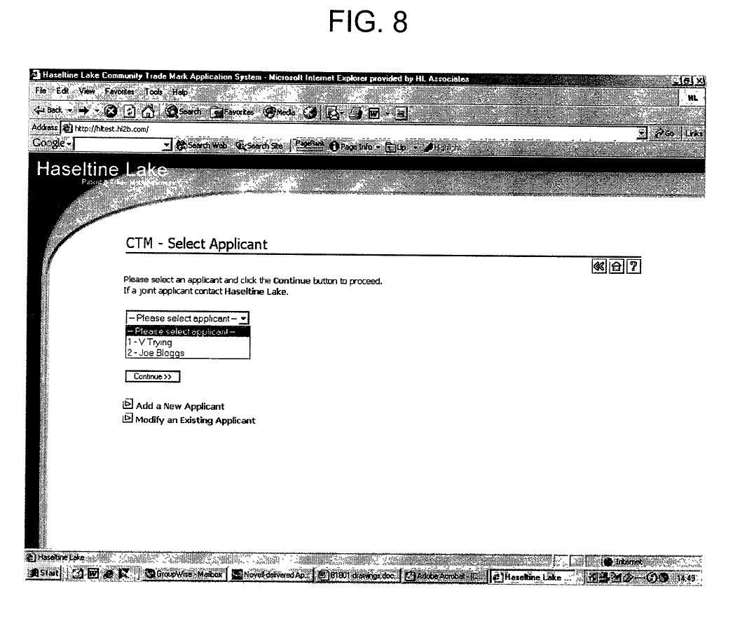

In S2, the client 10 is asked to name the applicant for the application for registration of the trademark concerned. Each client 10 is able to maintain its own private collection of applicant details in the applicant database 610. The applicant portion 530 which controls the input of the applicant details is therefore able to access the pre-stored applicant database 610 so that the client 10 is able simply to select a previously-stored applicant's details, as shown in the example screen shot of FIG. 8, or he may add a new applicant or modify an existing applicant stored in the applicant database 610 as shown in FIG. 8.

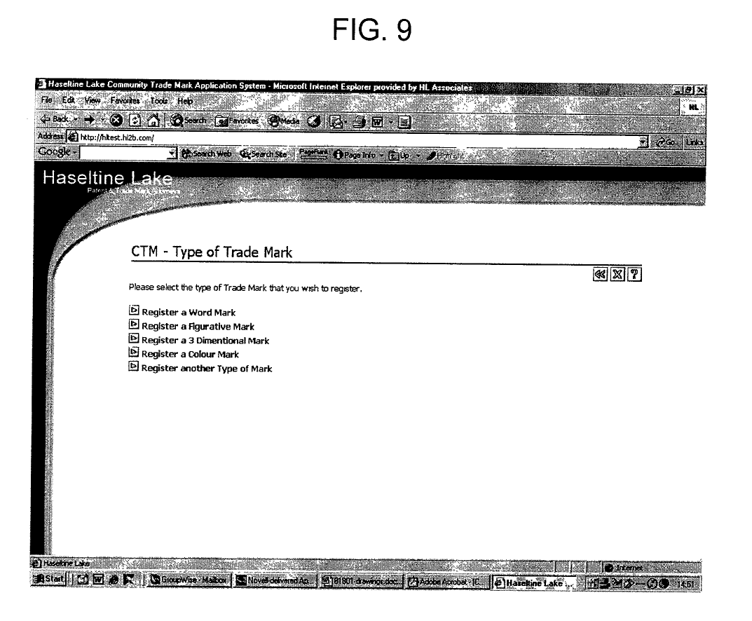

Once the applicant has been selected in step S2, processing passes to step S3, which is controlled by the mark portion 540 in FIG. 5. In step S3, the client 10 selects which type of trademark is to be registered, for example a word mark, a figurative mark, a three-dimensional mark, a colour mark or another type of mark. The types of mark that can be registered will vary from trademark jurisdiction to jurisdiction, but this information can be stored in the trademark information database 620 of the database unit 585 and used by the mark portion 540. An example screen shot relating to step S3 is shown in FIG. 9. Once the type of trademark to be registered has been chosen in step S3, processing passes to step S4.

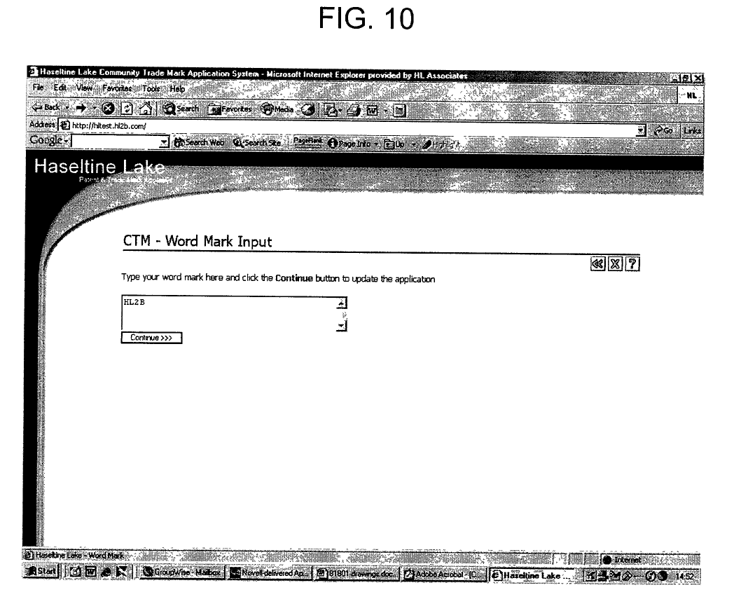

In step S4, also controlled by the mark portion 540, the details of the trademark to be registered are entered by the client 10 at the client terminal 100. For example, in the case where a word mark has been chosen in step S3, FIG. 10 shows an example screen shot relating to step S4 where the client 10 is asked to type in the word mark to be registered. This screen shot is displayed on the client terminal 100. For other types of trademark where a graphical representation is required for the trademark application, the mark portion 540 in step S4 will request the client 10 to provide, through the client terminal 100, a graphics file to be uploaded to the online filing server 500. The mark portion 540 can be resized automatically to enable thumbnails to be displayed, and to enable graphics to be printed on the application form. Once the details of the trademark to be registered have been input in step S4, processing passes to step S5.

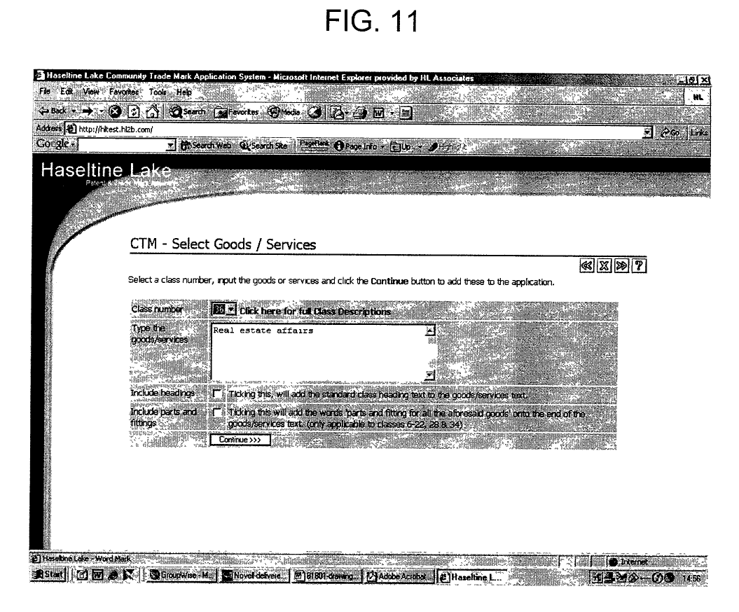

In step S5, also controlled by the mark portion 540, the client 10 is requested to select, via a screen displayed on the client terminal 100, the class number and the goods or services for which the trademark is desired to be registered. The exact details required will vary from trademark jurisdiction to jurisdiction, but the relevant details required can be accessed from the trademark information database 620 in the database unit 585. FIG. 11 shows an example screen shot relating to step S5, and shows that by clicking appropriate boxes on the client terminal 100, additional text can be added to the eventual trademark application form. Once this information has been input at the client terminal 100, processing passes to step S6.

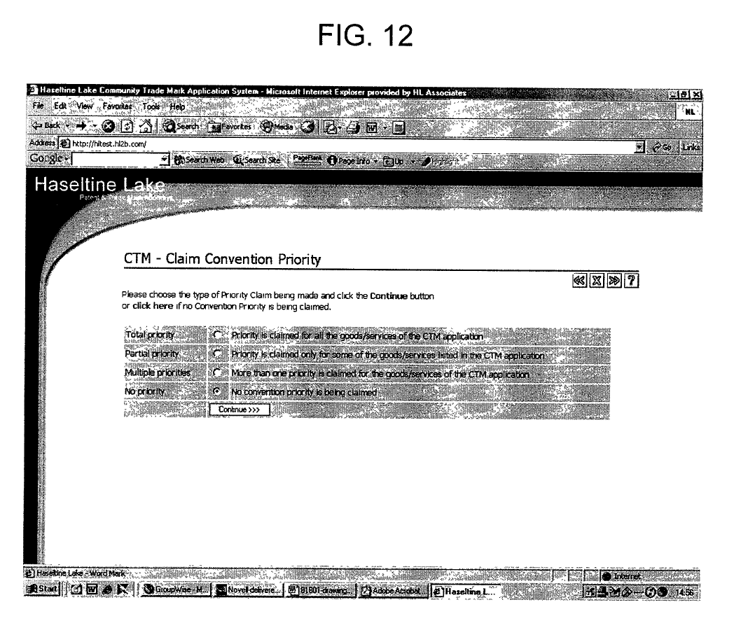

In step S6, controlled by the convention portion 550, a screen such as that shown in FIG. 12 is displayed on the client terminal 100 to request the client 10 to give details of any convention priority claim that is to be made in the application for registration of the trademark. If a priority claim is to be made, then processing passes to step S7 where the client 10 is requested to provide details of the priority claim; otherwise processing skips step S7 and passes directly to step S8.

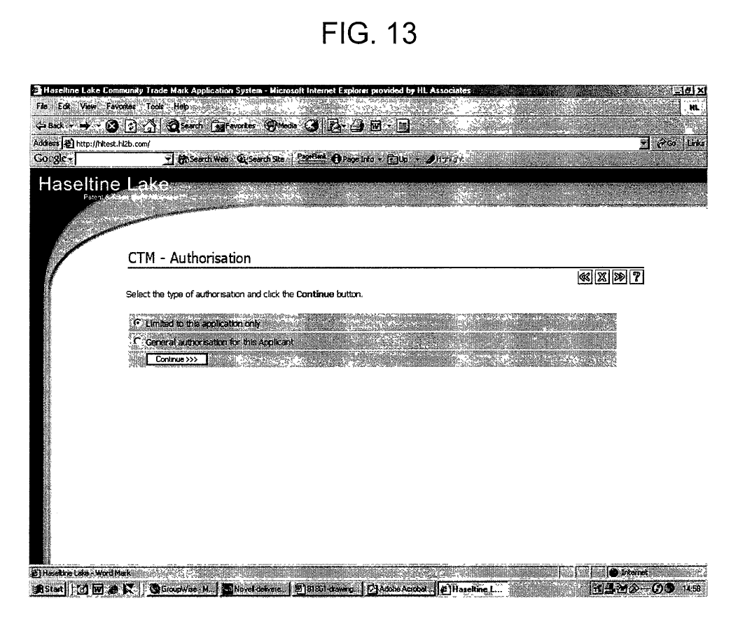

In step S8, controlled by the authorisation portion 560, the client 10 is requested to state which type of authorisation (or power of attorney) is applicable to the trademark application, as illustrated by the screen shot of FIG. 13.

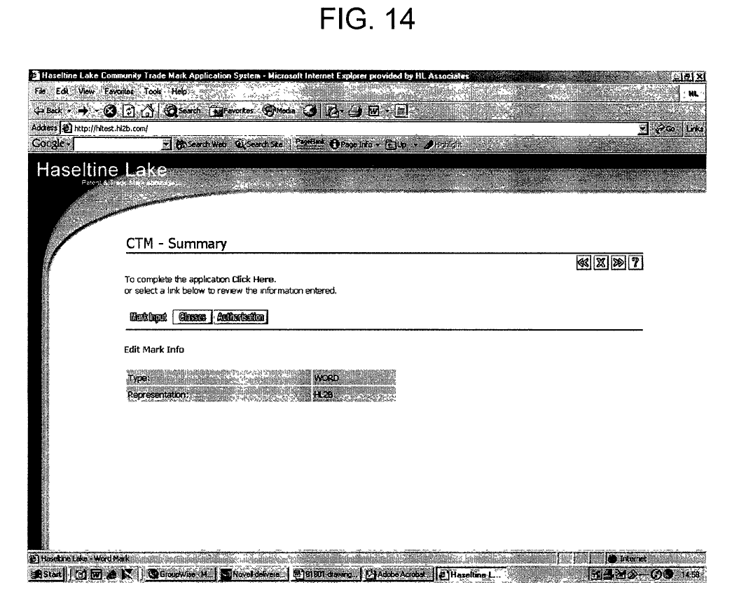

In step S9, controlled by the review portion 570, a review screen such as that shown in FIG. 14 is displayed on the client terminal 100. This gives the client 10 an opportunity to review and modify, if necessary, any information and details that have been provided in the process thus far. As shown in FIG. 14, tabs can conveniently be provided for quick access to different parts of the application to be reviewed. If the client 10 is satisfied that the information provided is correct, he can complete the application by clicking on a button provided on the client terminal 100 at this stage, to progress the procedure to step S10. Before completion, the client 10 is asked whether the application should be reviewed by the agent 30.

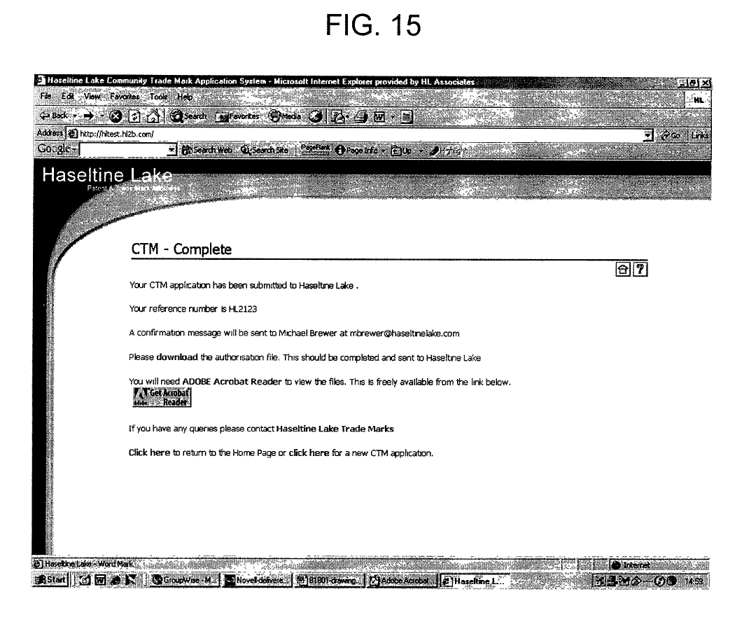

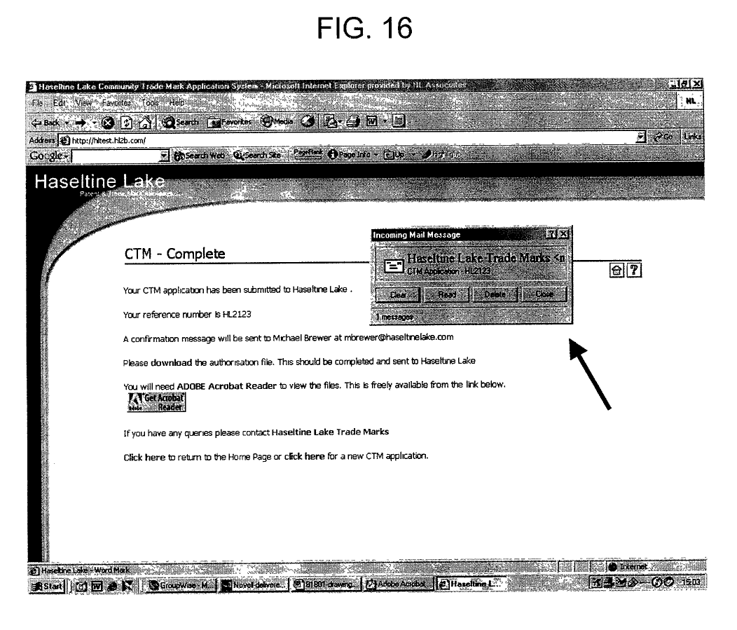

By this stage, all the information 20′ required to produce a completed trademark application form 50 has been entered by the client 10 via the client terminal 100. In step S10, controlled by the case completion portion 580, a screen such as that shown in FIG. 15 is displayed on the client terminal 100. On completion the following processing is done by the case completion portion 580. Firstly, a formatted electronic trademark application form 50′ (for example in the PDF format) is generated by the form producing unit 650 and sent via the network 400 both to the client terminal 100 and to the agent terminal 200. If required, an authorisation document is also generated for downloading by the client terminal 100; this authorisation file can be printed out by the client 10, completed and signed by the client 10 and sent via ordinary mail to the agent 30. The agent 30 is also e-mailed a copy of any special instructions provided by the client 10 during the application procedure outlined above. All details and information entered by the client 10 during the application procedure is stored in a case database 640 in the database unit 585. The client 10 is also sent a confirmation message which confirms that his application has been forwarded to the agent 30. This message is received at the client terminal 100, for example by e-mail as shown in FIG. 16.

When the agent 30 receives the completed electronic trademark application form 50′ at the agent terminal 200, he is then able to print out a hard copy version 50 of the trademark application, and file it at the trademark office 60 concerned.

Incidentally, every action taken or requested at the on-line filing server 500 is logged in a log database 630 so as to enable a system check to be performed if necessary. Various other system parameters required for the application procedure are stored in a system parameter database 635 in the database unit 585.

If, during the application procedure outlined above, the client 10 has requested that the agent 30 makes a review of his trademark application before it is submitted to the trademark filing office 60, the agent 30 makes a thorough review of the details provided. If any errors or omissions are found, the agent will be able to correct these errors as described below. However, before describing how errors in a client case file can be corrected, a brief description will first be made of the administrative set-up of the on-line filing server 500.

A list of users who are entitled to use the online filing system, either as a client or as an administrator or agent, is maintained by the user management portion 700 of the agent and administration unit 690, with access to a user database 590 of the database unit 585. Users are either administrators or clients. Client users are linked with a particular client, so that they can only access data for that client. Administrators or agents can perform other administrative tasks as set out below.

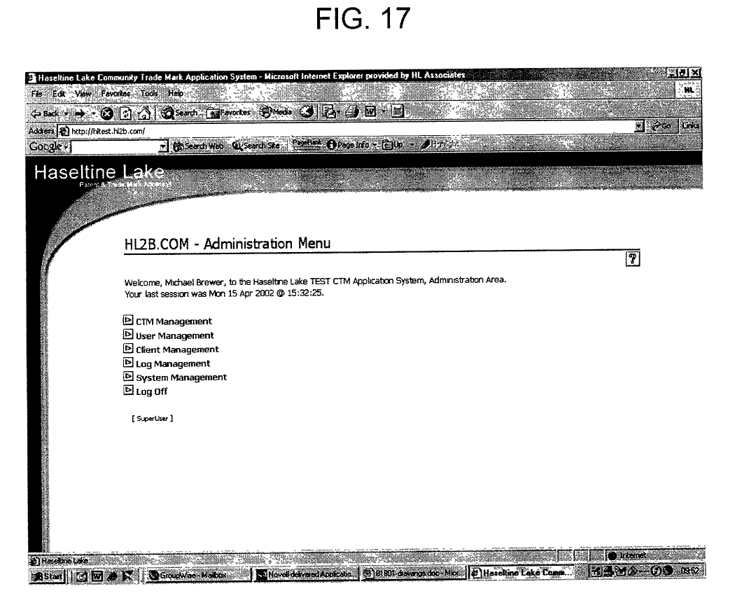

To perform these administrative tasks, the agent or administrator will first log on to the on-line filing server 500 from his terminal (either the agent terminal 200 or the administrator terminal 300, which may be one and the same terminal), and following a login process like that described above with reference to FIG. 7. He will then be presented with a list of administrative tasks displayed on his terminal such as that shown in the screen shot shown in FIG. 17.

An administrator can maintain, modify or update the list of clients in the client database or the applicants in the applicant database 610 via interaction with the client management portion 710 of the agent and administration unit 690. The administrator can also update the trademark information database 620, which stores information specific to the trademark jurisdiction in question, using the trademark management portion 710. Likewise various other system parameters which are stored in the system parameter database 635 can be maintained through the system management portion 740. As mentioned above, any action performed either by a client or by an administrator is logged in the log database 630 of the database unit 585. This allows the administrator to track and check any actions which have been performed, and to locate the source of any error which may have occurred. These functions are performed by the log management portion 730 of the agent and administration unit 690.

Returning to the situation where an agent has reviewed a client's submission and wishes to make corrections, the agent will log in to the on-line filing server 500 from his terminal 200 with the access privilege of an administrator. Under control of the case management portion 750 of the agent and administration unit 690, he is then able to enter (for example) a reference number that identifies the case in question. All the relevant information relating to the case will have been previously entered and stored into the case database 640 of the database unit 585 by the client 10 who performed the original application procedure from his client terminal 100. The agent 30 is then able, from his agent terminal 200, to modify the information stored in the case database 640 relating to the erroneous case, and once he has performed the corrections a new electronic form 50′ can be requested to be produced by the form producing unit 650. This electronic form 50′ is sent via the output portion 670 of the on-line filing server 500 through the network 400 to the agent terminal 200, so that the agent is subsequently able to print out a new hard-copy application form 50 for submission to the trademark office 60.

Although it has been described above that the agent terminal 200 is connected to a remote on-line filing server 500 through a network 400 such as the Internet, it will be appreciated that this connection may be made via a local network, or alternatively the on-line filing server 500 may be formed as part of the agent terminal 200 itself, so that the client terminal 100 accesses the agent terminal 200 directly through the network 400. In addition, all administrative tasks performed by the administrator terminal 300 may be carried out from the agent terminal 200, if desired. Therefore, the administrator terminal 300 and the agent terminal 200 can be one and the same terminal. Furthermore, the client terminal 100 and the agent terminal 200 may be connected not via a large-scale network but instead by a local area network. It is also not necessary that a hard-copy application form 50 is produced; instead, if the trademark office 60 concerned accepts such a procedure, the electronic application form 50′ may be communicated directly to the trademark office 60. Additional information, such as an electronic signature of the agent, or any other information deemed desirable or required by the office concerned may be transmitted in addition to the electronic application form.

Although in the above-described embodiment, the on-line filing server 500 includes a form producing unit 650 which produces an electronic application form 50′ at the site of the on-line filing server 500, it will be appreciated that it is also possible instead for the on-line filing server 500 merely to send sufficient information, in whatever form, to the agent terminal 200 such that the agent terminal 200 can itself either produce an electronic application form 50′ or directly produce a hard-copy application form 50.

It will also be appreciated that much of the control and processing which is described above as being performed within the on-line filing server 500 could instead be performed at the site of the client terminal 100 or the agent terminal 200, whichever is appropriate. For example, the client terminal 100 could perform much of the information-gathering process described above as being performed within the on-line filing server 500, for example control of the entering of the applicant details and the details of the trademark to be registered. The information which is gathered at the site of the client terminal 100 could then be communicated to the central on-line filing server 500 such that subsequent processing is performed from there, such as the generation of the electronic application form 50′ and any subsequent administrative tasks.

It is preferable, for the sake of convenience and ease of access by the client 10, that the on-line filing server 500 is accessible via the Internet. The interaction between the client terminal 100 and the online filing server 500 can then conveniently be achieved using the common web interface of a web browser displaying the queries Q of FIGS. 3 and 5 on a web page displayed on the client terminal 100. Likewise the administrative functions can also conveniently be performed via this web-type interface.

In one application envisaged for an on-line document filing system embodying the present invention, the application for registration of a trademark is an application for registration of a Community Trade Mark (CTM) and the office 60 at which the produced form 50 is filed is the Office for Harmonization of the Internal Market (OHIM). In such an application the client 10 and client 100 may be located in the US, while the agent 30 and the agent terminal 200 are located in a European state such as the UK. The online document filing system embodying the present invention is particularly beneficial in such a case because the CTM requires representation of an applicant by an agent qualified to act before OHIM. Using the on-line document filing system embodying the present invention an applicant or trademark agent based, for example, in the US can carry out much of the work involved in filing the trademark application, and therefore reduce his costs, whilst still having the extra benefit of professional representation before OHIM by a qualified agent.

The operations performed by the on-line filing server 500 can be controlled by a computer program run on the on-line filing server 500. This computer program can be stored on a computer-readable medium, although it will be appreciated that a computer program embodying the present invention need not be stored on a computer-readable medium and could, for example, be embodied in a signal such as a downloadable data signal provided from an Internet website. The appended claims are to be interpreted as covering a computer program by itself, or as a record on a carrier, or as a signal, or in any other form.

While the above embodiment has been described in relation to the filing of a trademark application, the invention may be used for the filing of any document through the intermediary of an agent. For example, the document to be filed may be any type of intellectual property document, such as a registered design application or a patent application. Similarly, the office at which the document is to be filed may be any type of office, for example an administration office such as a trademark registry or office, a design registry or office, or a patent registry or office.

Other modifications of detail can be made within the scope of the invention as set forth in the appended claims.

What is claimed is:

1. An electronic document filing apparatus which enables an agent to file a document at an office on behalf of a client, said apparatus comprising:
a client interaction unit which prompts the client for information relating to the document, and receives said information from the client;
a document producing unit which produces an electronic version of the document from the information received from the client; and
a communication unit which communicates said electronic version of said document to said agent to enable the agent to file said document at said office.

2. An apparatus as claimed in claim 1, wherein said client is remote from said client interaction unit, and said client interaction unit is in communication with said client via a network.

3. An apparatus as claimed in claim 2, wherein said network is the Internet.

4. An apparatus as claimed in claim 1, wherein said client interaction unit is located at a client terminal.

5. An apparatus as claimed in claim 1, wherein said document is an intellectual property document and said office is an intellectual property office.

6. An apparatus as claimed in claim 1, wherein said document is one of a trademark application, a design application and a patent application.

7. An apparatus as claimed in claim 1, wherein said communication unit communicates said electronic version of said document to said agent at an agent terminal.

8. An apparatus according to claim 7, wherein said agent terminal comprises a printer which prints a hard copy of said document for filing by said agent at said Office.

9. An apparatus according to claim 7, wherein said agent terminal transmits said electronic version of said document to said office.

10. An apparatus as claimed in claim 1 wherein said communication unit transmits said electronic version of said document to said office in response to an input from said agent.

11. An apparatus as claimed in claim 1, wherein said client interaction unit receives said information from said client via a system of menu-based queries displayed on a client terminal.

12. An apparatus as claimed in claim 1, further comprising a store for storing information received by said client interaction unit on a case-by-case basis, and a case management portion accessible by said agent which enables modification of said stored information and the subsequent production of a new document by said document producing unit.

13. An apparatus as claimed in claim 1, wherein said communication unit sends a confirmation message to said client confirming the receipt of said information.

14. An apparatus as claimed in claim 13, wherein said confirmation message includes a copy of said electronic version of said document.

15. An apparatus as claimed in claim 1, wherein said document is an application for registration of a Community Trade Mark (CTM) of the European Union and said office is the Office for Harmonization of the Internal Market (OHIM).

16. An electronic document filing system which enables an agent to file a document at an office on behalf of a remote client, said apparatus comprising:
a client terminal;
an on-line filing server in communication with said client terminal via a network; and
an agent terminal in communication with said online filing server, said on-line filing server comprising:
a client interaction unit which prompts said remote client terminal for information relating to the document via said network, and receives said information from the remote client terminal via said network;
a document producing unit which produces an electronic version of the document from the information received from the remote client terminal; and
a communication unit which communicates said electronic version of said document to said agent terminal to enable the agent to file said document at said office.

17. A client terminal which is programmed to enable a client to instruct an agent to file an intellectual property document at a remote intellectual property office, the client terminal comprising:
a client interaction unit which prompts the client for information relating to the document, and receives said information from the client;
a document producing unit which produces an electronic version of the document from the information received from the client; and
a communication unit which communicates said electronic version of said document to said agent to enable the agent to file said document at said office.

18. An electronic document filing method which enables an agent to file a document at an office on behalf of a client, said method being carried out electronically and comprising the steps of:
prompting said client for information relating to said document;
receiving said information from said client;
producing an electronic version of the document from the information received from the remote client; and
communicating said electronic version of said document to said agent to enable the agent to file said document at said office.

19. A method as claimed in claim 18, wherein the steps of prompting the client and receiving said information are carried out by a client interaction unit which is remote from said client, and said client interaction unit communicates with said client via a network.

20. A method as claimed in claim 19, wherein said network is the Internet.

21. A method as claimed in claim 19, wherein the steps of prompting the client and receiving said information are carried out at a client terminal.

22. A method as claimed in claim 19, wherein said document is an intellectual property document and said office is an intellectual property office.

23. A method as claimed in claim 19, wherein said document is one of a trademark application, a design application and a patent application.

24. A method as claimed in claim 19, further comprising the step of printing a hard copy of said document for filing by said agent at said office.

25. A method according to claim 19, further comprising the step of transmitting said electronic version of said document to said office.

26. A method as claimed in claim 19, further comprising the step of sending a confirmation message to said client confirming the receipt of said information.

27. A method of instructing an agent to file an intellectual property document at a remote intellectual property office, the method comprising the steps of:
logging on to an electronic filing apparatus provided by the agent;
receiving a prompt for information relating to said document from said electronic filing apparatus;
sending information relating to said document to said electronic filing apparatus; and
receiving confirmation that said information has been received.

28. An electronic document filing apparatus for enabling an agent to file a document at an office on behalf of a client, the apparatus comprising:
means for prompting the client for information relating to the document, means for receiving said information from the client;
means for producing an electronic version of the document from the information received from the client; and
means for communicating said electronic version of said document to said agent to enable the agent to file said document at said office.

29. A computer readable recording medium storing a program for use in an electronic document filing apparatus which enables an agent to file a document at an office on behalf of a client, said program comprising:
a client interaction program portion which prompts the client for information relating to the document, and receives said information from the client;
a document producing program portion which produces an electronic version of the document from the information received from the client; and
a communication program portion which communicates said electronic version of said document to said agent to enable the agent to file said document at said office.

30. A computer readable recording medium storing a program for use in a client terminal which is programmed to enable a client to instruct an agent to file an intellectual property document at a remote intellectual property office, the program comprising:
a client interaction program portion which prompts the client for information relating to the document, and receives said information from the client;
a document producing program portion which produces an electronic version of the document from the information received from the client; and
a communication program portion which communicates said electronic version of said document to said agent to enable the agent to file said document at said office.
